(19) United States
(12) Patent Application Publication
(10) Pub. No.: US 2013/0078452 A1
(43) Pub. Date: Mar. 28, 2013

(54) QUICK DRYING SEMI-SOLID GLUES

(71) Applicant: Tao Xie, Troy, MI (US)

(72) Inventor: Tao Xie, Troy, MI (US)

(73) Assignee: GM Global Technology Operations LLC, Detroit, MI (US)

(21) Appl. No.: 13/242,733

(22) Filed: Sep. 23, 2011

(51) Int. Cl. B32B 7/12; C09J 7/02; B32B 37/12; B32B 27/36; B32B 27/00; B32B 27/38; B32B 27/30; B32B 27/40; B32B 5/00; B32B 38/16

(52) U.S. Cl. 428/336; 428/346; 156/60; 428/411.1; 428/413; 428/704; 428/522; 428/500; 428/423.1; 428/480

(57) ABSTRACT

An exemplary embodiment discloses a shape memory polymer material (SMP) including a glue material chemically grafted onto a surface of the SMP material wherein the SMP material is capable of transforming between a permanent shape and a temporary shape.

### TECHNICAL FIELD

The field to which the disclosure generally relates includes glues (adhesive materials) and shape memory polymeric (SMP) materials, and more specifically to a glue chemically grafted onto a shape memory polymeric surface whereby the amount of glue and solvent used in a bonding process may be minimized to achieve a quick drying bonding process.

### BACKGROUND

Shape memory polymers (SMP's) represent responsive polymers that can fix to deformed temporary shapes and recover to their permanent (original) shapes only upon external stimuli. In particular, SMPs which are responsive to temperature and possessing one glass transition temperature (Tg) are finding increasing use in a wide array of products.

### SUMMARY OF EXEMPLARY EMBODIMENTS OF THE INVENTION

In an exemplary embodiment, a shape memory polymer material (SMP) including a glue material chemically grafted onto a surface of the SMP material is provided wherein the SMP material is capable of transforming between a permanent shape and a temporary shape.

In another exemplary embodiment, a method of gluing a substrate is presented including providing a shape memory polymer (SMP) material wherein the SMP material is capable of transforming between a permanent shape and a temporary shape; providing a dry glue chemically grafted to at least one surface of the SMP material; heating the SMP material above a glass transition temperature T_{g} of the SMP material; contacting the dry glue with a solvent to solvate said glue; contacting the solvated glue with at least a first substrate; and, drying the solvated glue to form an adhesion bond to said at least a first substrate.

In another exemplary embodiment, a product with an adhesive bond is provided, the adhesive bond including at least one layer of shape memory polymer (SMP) material wherein the SMP material is capable of transforming between a permanent shape and a temporary shape; a glue material chemically grafted to at least one surface of the SMP material; and, at least one substrate glued to the at least one glue containing surface of said SMP material.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIGS. 1A-1F show schematic diagrams of shape memory polymer (SMP) material with grafted glue surfaces according to embodiments of the invention.

FIG. 2 shows a 3-dimensional shape memory plot of temperature versus stress and strain of SMP material according to embodiments of the invention.

FIG. 3 shows a process flow according to embodiments of the invention.

### DETAILED DESCRIPTION OF EXEMPLARY EMBODIMENTS

The following description of the embodiment(s) is merely exemplary (illustrative) in nature and is in no way intended to limit the invention, its application, or uses.

In an exemplary embodiment, a glue material may be chemically grafted (chemically bonded) onto a shape memory polymer (SMP) surface to form a glue containing shape memory polymer surface. The term ‘chemically grafted’ is meant including at least one chemical bond formed between a chemical group comprising the SMP material and a chemical group comprising the glue material. It will be appreciated that the glue material is preferably different from the SMP material. A solvent may then be contacted onto the glue material above or below a T_{g} of the SMP material, and in one exemplary embodiment, above a T_{g} of the SMP material. A substrate may then be contacted onto the solvent activated glue on the SMP and the substrate and SMP cooled below the T_{g} of the SMP material to form the SMP material bonded to the substrate.

In an exemplary embodiment, the glue may be any glue that may be chemically grafted onto the SMP material and which may be solvated with a solvent. For example, the glue material includes solvent in a pre-adhesion forming state prior to drying to form an adhesion state. In some embodiments, exemplary glue materials may include ethylene-vinyl acetate, polyvinyl alcohol, polyurethanes, polyester, ethylene-vinyl acetate, polyvinyl acetate (PVA), polysulfides, and polyvinyl chloride (PVC). In select embodiments the solvents may include, but are not limited to, isopropanol, water, toluene or acetone.

In another exemplary embodiment, the shape memory polymer (SMP) material may include one or more glass transition temperatures (T_{g}) and/or Tₘ (melting points), hereinafter referred to generally as T_{g}.

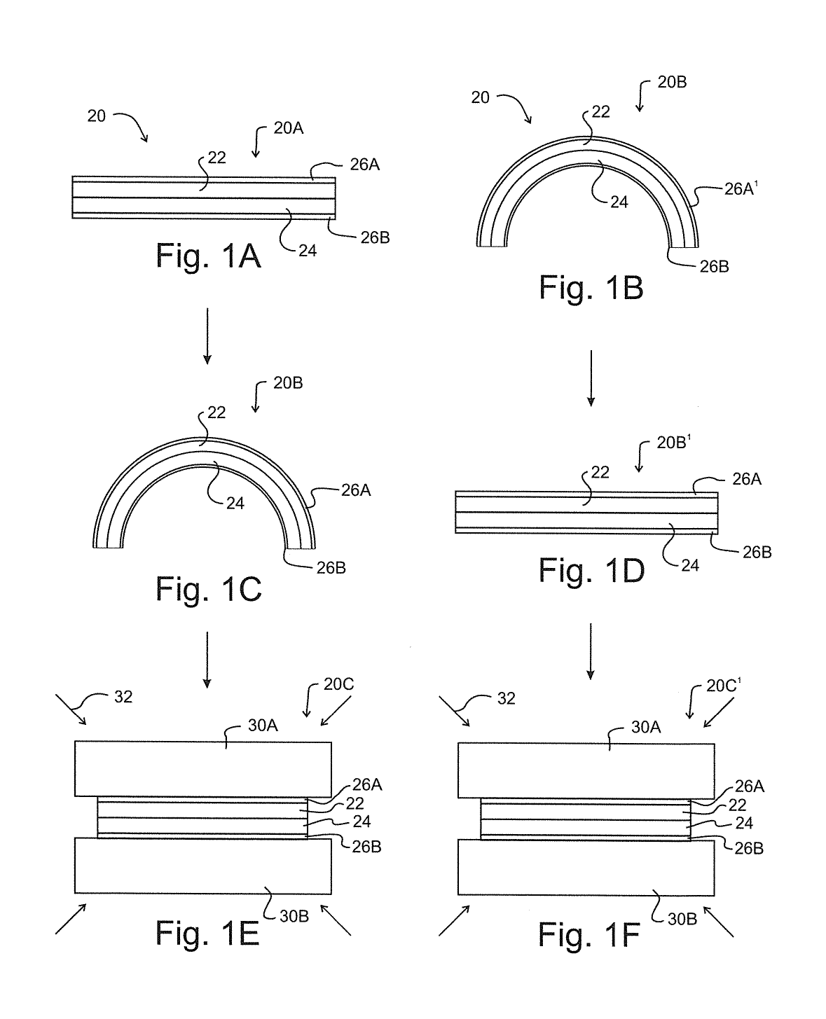

For example, in one exemplary embodiment, referring to FIGS. 1A and 1B, the SMP material 20 may have single or multiple layers e.g., 22, 24, where the multiple layers may also be glued together with a glue material according to preferred embodiments. In another exemplary embodiment the SMP material at a first lower temperature, e.g., about room temperature (about 25° C.), may have a first shape that may be a temporary shape or a permanent shape. For example, referring to FIG. 1A, the SMP material may have a shape 20A with substantially flat surface when the SMP material is at a temperature below a T_{g} of the SMP material. The temporary shape may be formed by applying stress above a T_{g} of the SMP material and subsequently cooled below the a T_{g} with the stress applied, and then releasing the stress to form the temporary shape, i.e., where the temporary shape is fixed or frozen into the SMP material below the T_{g}, (strain fixed below T_{g}). The temporary shape may revert to its original (permanent) shape without applied stress upon heating above the T_{g} (e.g., relaxation of strain).

In various embodiments, the at least one T_{g} of the SMP material may be within a range of from about 25° C. to about 200° C.

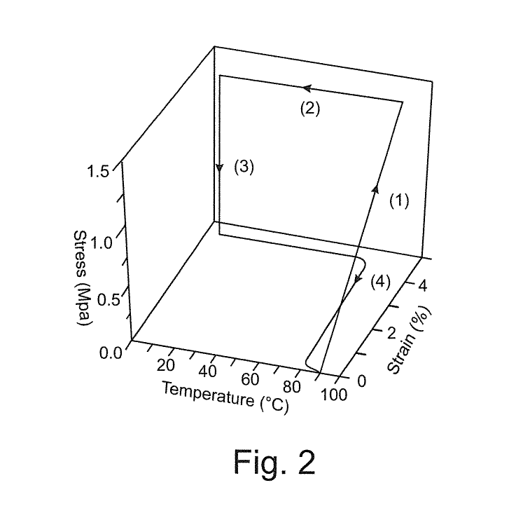

Referring FIG. 2, in an exemplary embodiment, is shown a 3-dimensional plot of temperature versus both stress and strain in an exemplary shape memory cycle of an exemplary SMP material. As the SMP material is heated above a T_{g} of an exemplary SMP material, the strain is relaxed to about 0% (4) (e.g., in a permanent shape); stress and a resulting strain may then be applied to the SMP material above the T_{g} (1); the temperature may then be cooled with stress applied below the T_{g} (2); the stress may then be released (3), but the strain (temporary shape) is temporarily fixed into the SMP material below the T_{g}.

In various embodiments, the SMP material may include a rigid epoxy, an epoxy extender, and a crosslinking agent; or a rigid epoxy, a flexible crosslinking agent, and a flexible epoxy; or a rigid epoxy, a rigid crosslinking agent, and a flexible epoxy; or a rigid epoxy, a flexible epoxy, and a catalytic curing agent; or a rigid epoxy, a crosslinking agent, and a diluent; or a flexible epoxy, a crosslinking agent, and a diluent; or a rigid epoxy and a flexible crosslinking agent; or a flexible epoxy and a catalytic curing agent; or a flexible epoxy and a crosslinking agent; and wherein the rigid epoxy is an aromatic epoxy having at least two epoxide groups, the flexible epoxy is an aliphatic epoxy having at least two epoxide groups, the epoxy extender has one epoxide group, and the crosslinking agent is one of a multi-amine, an organic multi-carboxylic acid, or an anhydride, and the diluent is a monoamine or a mono-carboxylic acid. In various embodiments, the catalytic curing agent (or catalytic cure) promotes epoxy-to-epoxy or epoxy-to-hydroxyl reactions. The catalytic curing agent may include, but is not limited to, tertiary amines, amine salts, boron trifluoride complexes, or amine borates. In one embodiment, the components of the dry SMP material (which may also be a dry adhesive) may be present in an amount sufficient to provide, upon curing of the composition, an SMP material having a glass transition temperature (Tg) of from about 25° C. to about 200° C.

In another exemplary embodiment, the shape memory polymer (SMP) material may be formed from and/or include a rigid aromatic diepoxide (EPON 826), a flexible aliphatic diepoxide such as neopentyl glycol diglycidyl ether (NGDE), and an aliphatic diamine curing agent such as poly(propylene glycol)bis(2-aminopropyl)ether (Jeffamine D-230).

Still referring to FIGS. 1A and 1B, in one exemplary embodiment, a glue material e.g., 26A, 26B may be chemically attached or grafted onto one or more surfaces, e.g., upper surface of layer 22 and lower surface of layer 24. For example, unreacted groups such as epoxy or amine groups on the surface of the SMP material may react with the glue material to form chemical bonds with the glue material. In one embodiment, the SMP material 20 may be chemically treated with the glue material to form dry (substantially without solvent following reaction and drying) glue material e.g., 26A, 26B, chemically attached (bonded) to one or more surfaces of the SMP material. In other embodiments, the glue material e.g., 26A, 26B may be formed as layers in any pattern to cover a portion or all of respective exposed bonding surfaces of the SMP material 20. The glue layers may be from a monolayer to several monolayers in thickness, for example the dried glue material having a thickness ranging from about 5 Angstroms to about 1 micron in thickness, more preferably ranging from about 5 Angstroms to about 20 nanometers in thickness.

Referring to FIGS. 1C and 1D, in an exemplary embodiment, the SMP material 20 as shown with respective shapes 20A and 20A′ in FIGS. 1A and 1B with the grafted glue material e.g., 26A, 26B may be heated above at least one T_{g} of the SMP material to form a respective second shape, e.g., 20B and 20B′ as shown in respective FIGS. 1C and 1D, where the second shape may include either a strain relaxed state (permanent shape) without an imposed stress or a strained state (temporary shape) under an imposed stress.

In another exemplary embodiment, following heating of the SMP material above T_{g}, either prior to or following formation of a second shape e.g., 20B and 20B′, the glue material e.g., 26A, 26B may be contacted with a solvent material, e.g., by one or more of dipping, spraying, brushing, and the like. In one embodiment, it will be appreciated that the amount of solvent material contacted to the glue material e.g., 26A, 26B may be about equal to an amount sufficient to solvate the glue material, e.g., about the same volume or less of than the volume of the dry glue material. It will be appreciated that in some embodiments, the solvent may cause the glue material to be activated.

In another embodiment, the SMP material (e.g., layers 22 and 24) preferably remains substantially unsolvated (dry) while only the glue material e.g., 26A, 26B is solvated, although it will be appreciated that some of the solvent may contact exposed surfaces of the SMP material. It will further be appreciated that the preferred type of solvent is capable of solvating the dry glue material without detaching the grafted glue material from the surface of the SMP material.

In another exemplary embodiment, as shown in FIGS. 1E and 1F, one or more substrates e.g., 30A, 30B, may then be contacted to the solvated glue material, e.g., 26A, 26B while imposing a stress (strain) on the glue material 26A, 26B and the SMP material e.g., 22, 24, as indicated by arrows e.g., 32. The stress may further be imposed by the weight of one or more of the substrates 30A, 30B, and/or by imposing the stress on one or more of the substrates (e.g., pressing, clamping etc.) onto one or more of the solvated glue containing surfaces of the SMP material. In some embodiment, it will be appreciated that the one or more substrates 30A, 30B, may be a material different than the SMP material e.g., including one or more of a polymer material, a ceramic, a metal, and a semiconductor.

In another embodiment, as shown in FIGS. 1E and 1F, a third shape e.g., 20C and 20C′ may be imposed on the SMP material above a T_{g} of the SMP material (above at least one T_{g} of one of the SMP material layers in a multi-layered material) by applying stress (strain) e.g., 32 on the one or more substrates e.g., 30A, 30B, while contacting the one or more substrates to the one or more glue containing surfaces e.g., 26A, 26B. For example, as shown in FIG. 1E, in one embodiment, a relaxed permanent curved shape 20B in FIG. 1C may be flattened by pressing the shape 20B between one or more of the substrates e.g., 30A, 30B, above a T_{g} of the SMP material to form a temporary (strained) third shape 20C. It will be appreciated that the flat shape 20B′ as shown in FIG. 1D may be a permanent (strain relaxed) shape and may have a stress (strain) imposed by further flattening the second shape 20B′ between the one or more substrates e.g., 30A, 30B, to form a temporary (strained) third shape 20C′.

In another embodiment, following contacting with applied stress the solvent containing glue material with one or more substrates e.g., 30A, 30B, to form the third shape e.g., 20C and 20C′ above a T_{g} of the SMP material, the SMP material, substrates, and solvent containing glue material may then be cooled to a temperature below T_{g} where an applied stress e.g., 32 may be released, prior to or following evaporation of the solvent, to form SMP material in respective shapes e.g., 20C and 20C′ and adhesion bonded through the glue material to the one or more substrates e.g., 30A, 30B.

For example, the second curved shape e.g., 20B, FIG. 1C may be obtained from the first flat shape e.g., 20A, FIG. 1A, by heating the SMP material to a first elevated temperature e.g., T_{high} and which may then be deformed (strained) under stress (e.g., flattened out between the substrates e.g., 30A, 30B following contacting the glue material with solvent) to yield a third shape 20C, FIG. 1E (e.g., flat). The temperature T_{high} may be a temperature sufficiently high to ensure a phase transition (above T_{g}) for the SMP material. The SMP material with shape 20C may then be cooled under the applied stress (e.g., while flattened between the substrates e.g., 30A, 30B) below T_{high}, wherein the stress may then be released following drying of the glued surfaces (evaporation of solvent) to fix the third shape 20C bonded (glued) to the substrates e.g., 30A, 30B.

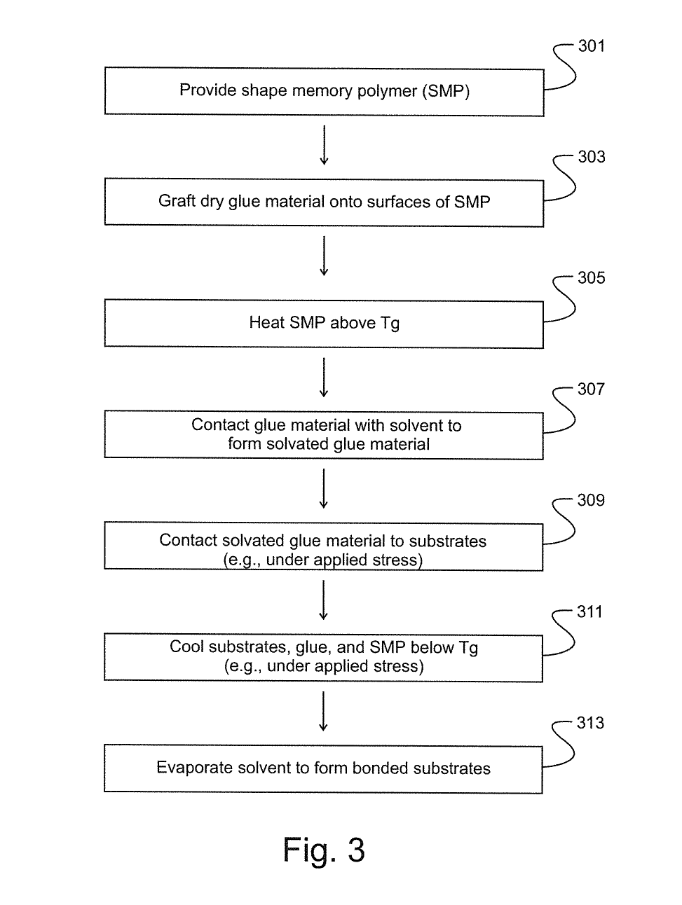

Referring to FIG. 3 is shown an exemplary process flow according to several embodiments. In step 301, a shape memory polymer (SMP) having a first shape and one or more T_{g}'s is provided. In step 303, dry glue may be grafted onto one or more surfaces of the SMP. In step 305, the SMP may be heated above a T_{g}. In step 307, a solvent may be applied to the dry glue to form solvated glue on the SMP surface. In step 309, one or more substrates may be contacted to the solvated glue containing SMP surface which may be under an applied stress. In step 311, the one or more substrates contacting the solvated glue containing SMP surface may be cooled below a T_{g} of the SMP material which may be under an applied stress. In step 313, the solvent may be evaporated from the glue material at one or more temperatures below T_{g} to form the one or more bonded substrates e.g., bonded together through the SMP material where the stress may be released before or after drying of the solvent.

Among the various advantages of the embodiments include the reduction of the amount of solvent required in a gluing process which serves to reduce environmentally harmful vapors as well as to ensure a gluing process that has a quick drying time.

The above description of embodiments of the invention is merely exemplary in nature and, thus, variations thereof are not to be regarded as a departure from the spirit and scope of the invention.

What is claimed is:

1. A product comprising:
a glue material chemically grafted to a surface of an SMP material wherein said SMP material is capable of transforming between a permanent shape and a temporary shape.

2. A product as set forth in claim 1, wherein said SMP material comprises a single glass transition temperature (T_{g}).

3. A product as set forth in claim 1, wherein said SMP material comprises multiple glass transition temperatures (T_{g}).

4. A product as set forth in claim 1, wherein said SMP material comprises at least one of:
a rigid epoxy, a flexible epoxy, an epoxy extender, a flexible crosslinking agent, a rigid crosslinking agent, a catalytic curing agent, or a diluent.

5. A product as set forth in claim 4, wherein:
the rigid epoxy is an aromatic epoxy having at least two epoxide groups, the flexible epoxy is an aliphatic epoxy having at least two epoxide groups, the epoxy extender has one epoxide group, and the crosslinking agent is one of a multi-amine, an organic multi-carboxylic acid, and an anhydride, and the diluent is a monoamine or a mono-carboxylic acid.

6. A product as set forth in claim 4, wherein the catalytic curing agent comprises at least one of tertiary amines, amine salts, boron trifluoride complexes, or amine borates.

7. A product as set forth in claim 1, wherein said SMP material comprises a rigid aromatic diepoxide (EPON 826), a flexible aliphatic diepoxide such as neopentyl glycol diglycidyl ether (NGDE), and an aliphatic diamine curing agent such as polypropylene glycol)bis(2-aminopropyl)ether (Jeffamine D-230).

8. A product as set forth in claim 1, wherein said glue material is capable of being solvated to become a solvated glue material while chemically grafted to said SMP material.

9. A product as set forth in claim 1, wherein said glue material comprises at least one of ethylene-vinyl acetate, polyvinyl alcohol, polyurethanes, polyester, ethylene-vinyl acetate, polyvinyl acetate (PVA), polysulfides, and polyvinyl chloride (PVC).

10. A product as set forth in claim 1, wherein said glue material has a thickness of from about 1 nm to about 1 micron.

11. A product as set forth in claim 1, wherein said SMP material is in a permanent shape.

12. A product as set forth in claim 1, wherein said SMP material is in a temporary shape.

13. A method comprising:
providing a shape memory polymer (SMP) material wherein said SMP material is capable of transforming between a permanent shape and a temporary shape;
providing a glue chemically grafted to at least one surface of said SMP material;
heating said SMP material above a glass transition temperature T_{g} comprising said SMP material;
contacting said glue with a solvent to solvate said glue;
contacting said solvated glue with at least a first substrate; and,
drying said solvated glue to form an adhesion bond to said at least a first substrate.

14. The method of claim 13, wherein said glue is attached to two surfaces of said SMP material and said solvated glued on each of said two surfaces is respectively contacted by said at least a first substrate and a second substrate.

15. The method of claim 14, wherein said SMP material is pressed between said at least a first substrate and said second substrate.

16. The method of claim 13, wherein said step of contacting said solvated glue with said at least a first substrate is performed under an applied stress.

17. The method of claim 13, wherein said step of drying comprises cooling below said T_{g} said at least a first substrate contacted to said solvated glue surface.

18. The method of claim 17, wherein said cooling is performed under an applied stress.

19. The method of claim 13, wherein said step of contacting said glue with a solvent comprises at least one of dipping, spraying, or brushing.

20. The method of claim 13, wherein said SMP material comprises at least one of:
a rigid epoxy, a flexible epoxy, an epoxy extender, a flexible crosslinking agent, a rigid crosslinking agent, a catalytic curing agent, and a diluent.

21. The method of claim 20, wherein:
the rigid epoxy is an aromatic epoxy having at least two epoxide groups, the flexible epoxy is an aliphatic epoxy having at least two epoxide groups, the epoxy extender has one epoxide group, and the crosslinking agent is one of a multi-amine, an organic multi-carboxylic acid, and an anhydride, and the diluent is a monoamine or a mono-carboxylic acid.

22. The method of claim 20, wherein the catalytic curing agent comprises at least one of tertiary amines, amine salts, boron trifluoride complexes, or amine borates.

23. The method of claim 13, wherein said SMP material comprises a rigid aromatic diepoxide (EPON 826), a flexible aliphatic diepoxide such as neopentyl glycol diglycidyl ether (NGDE), and an aliphatic diamine curing agent such as poly(propylene glycol)bis(2-aminopropyl)ether (Jeffamine D-230).

24. The method of claim 13, wherein said glue material comprises at least one of ethylene-vinyl acetate, polyvinyl alcohol, polyurethanes, polyester, ethylene-vinyl acetate, polyvinyl acetate (PVA), polysulfides, and polyvinyl chloride (PVC).

25. The method of claim 13, wherein said glue material has a thickness of from about 1 nm to about 1 micron.

26. The method of claim 13, wherein said SMP material is in a temporary shape following said step of drying.

27. A product with an adhesion bond, said adhesion bond comprising:
at least one layer of shape memory polymer (SMP) material wherein said SMP material is capable of transforming between a permanent shape and a temporary shape;
a glue material chemically grafted to at least one surface of said SMP material; and,
at least one substrate glued to said at least one surface of said SMP material through said glue material comprising said adhesion bond.

28. The product of claim 27, wherein said SMP material comprises at least one glass transition temperature (T_{g}).

29. The product of claim 27, wherein said SMP material comprises at least one of:
a rigid epoxy, a flexible epoxy, an epoxy extender, a flexible crosslinking agent, a rigid crosslinking agent, a catalytic curing agent, or a diluent.

30. The product of claim 29, wherein:
the rigid epoxy is an aromatic epoxy having at least two epoxide groups, the flexible epoxy is an aliphatic epoxy having at least two epoxide groups, the epoxy extender has one epoxide group, and the crosslinking agent is one of a multi-amine, an organic multi-carboxylic acid, and an anhydride, and the diluent is a monoamine or a mono-carboxylic acid.

31. The product of claim 29, wherein the catalytic curing agent comprises at least one of tertiary amines, amine salts, boron trifluoride complexes, or amine borates.

32. The product of claim 27, wherein said SMP material comprises a rigid aromatic diepoxide (EPON 826), a flexible aliphatic diepoxide such as neopentyl glycol diglycidyl ether (NGDE), and an aliphatic diamine curing agent such as poly(propylene glycol)bis(2-aminopropyl)ether (Jeffamine D-230).

33. The product of claim 27, wherein said glue material is capable of being solvated to become a solvated glue material while chemically grafted to said SMP material.

34. The product of claim 27, wherein said glue material comprises at least one of ethylene-vinyl acetate, polyvinyl alcohol, polyurethanes, polyester, ethylene-vinyl acetate, polyvinyl acetate (PVA), polysulfides, and polyvinyl chloride (PVC).

35. The product of claim 27, wherein said glue material has a thickness of from about 10 nm to about 1 micron.

36. The product of claim 27, wherein said SMP material is in a permanent shape.

37. The product of claim 27, wherein said SMP material is in a temporary shape.
